(19) United States
(12) Patent Application Publication
(10) Pub. No.: US 2025/0291924 A1
(43) Pub. Date: Sep. 18, 2025

(54) Field Firmware Upgrade for Industrial Power Supplies and Related Systems

(71) Applicant: APPLETON GRP LLC, Rosemont, IL (US)

(72) Inventors: Rahul Dnyandeo Kapse, Pune (IN); Earl Max Q. Cambronero, Binan City, Laguna (PH); John Allen Hendrix, JR., Pleasant Prairie, WI (US); Ravindra Viraj Gurjar, Pune (IN); Pawankumar Devanand Lohar, Pune (IN)

(21) Appl. No.: 18/633,780

(22) Filed: Apr. 12, 2024

(30) Foreign Application Priority Data
Mar. 14, 2024 (IN) 202421018648

(51) Int. Cl. G06F 21/57

(52) U.S. Cl. CPC G06F 21/572

(57) ABSTRACT

This disclosure includes a method performed by a first device. The method includes sending, to a server, a request to receive files configured for an installation on a second device or on a third device and to receive instructions for performing the installation of the files on the second device or the third device. The method also includes receiving the files and the instructions from the server. The method also includes executing the instructions, thereby sending the files to the second device or the third device and causing the files to be installed on the second device or the third device.

### CROSS REFERENCE TO RELATED APPLICATION

This application claims priority under 35 U.S.C. § 119 to Indian patent application no. 202421018648, filed on Mar. 14, 2024, the entire contents of which are incorporated by reference herein.

### FIELD

The present disclosure relates generally to methods for performing firmware updates of equipment in the field, and more specifically to performing firmware updates of industrial power supplies and related systems in the field.

### BACKGROUND

Industrial power supplies and related systems are typically not well suited for firmware upgrades to be performed in the field. For example, a field firmware upgrade of an industrial power supply or its communication module generally involves opening the housing of the device and using custom installation software, a dedicated programming cable, a dedicated connection port, and/or a data card to access the device to perform the firmware update. Opening and closing the housing of such devices can make them vulnerable to damage. Additionally, certain electrical terminals that are exposed by removing the housing can present safety issues. Removing the housing can also necessitate disconnecting all cables that are connected to the device. As such, more efficient and convenient methods for updating the firmware of industrial power supplies, uninterruptible power supply (UPS) systems, and related systems are needed.

### SUMMARY

A first example of the disclosure is a method performed by a server, the method comprising: receiving, from a first device, a request to receive files configured for an installation on a second device or on a third device and to receive instructions for performing the installation of the files on the second device or the third device; and sending the files and the instructions to the first device.

A second example of the disclosure is server comprising: one or more processors; and a computer readable medium storing instructions that, when executed by the one or more processors, cause the server to perform the method of the first example.

A third example of the disclosure is a non-transitory computer readable medium storing instructions that, when executed by one or more processors of a server, cause the server to perform the method of the first example.

A fourth example of the disclosure is a method performed by a first device, the method comprising: sending, to a server, a request to receive files configured for an installation on a second device or on a third device and to receive instructions for performing the installation of the files on the second device or the third device; receiving the files and the instructions from the server; and executing the instructions, thereby sending the files to the second device or the third device and causing the files to be installed on the second device or the third device.

A fifth example of the disclosure is a device comprising: one or more processors; and a computer readable medium storing instructions that, when executed by the one or more processors, cause the device to perform the method of the fourth example.

A sixth example of the disclosure is a non-transitory computer readable medium storing instructions that, when executed by one or more processors of a device, cause the device to perform the method of the fourth example.

A seventh example of the disclosure is a method performed by a first device, the method comprising: receiving files from a second device while the first device is in communication with a third device; discontinuing the communication between the first device and the third device and thereafter performing an installation of the files on the first device; and reestablishing communication with the third device after the installation.

An eighth example of the disclosure is a device comprising: one or more processors; and a computer readable medium storing instructions that, when executed by the one or more processors, cause the device to perform the method of the seventh example.

A ninth example of the disclosure is a non-transitory computer readable medium storing instructions that, when executed by one or more processors of a device, cause the device to perform the method of the seventh example.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The features, functions, and advantages that have been discussed can be achieved independently in various examples or may be combined in yet other examples further details of which can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a block diagram of a server and three devices, according to an example.

FIG. 2 is a schematic diagram of operations of a server and three devices, according to an example.

FIG. 3 is a block diagram of a method, according to an example.

FIG. 4 is a block diagram of a method, according to an example.

FIG. 5 is a block diagram of a method, according to an example.

### DETAILED DESCRIPTION

As noted above, a need exists for more efficient and convenient methods for updating the firmware of industrial power supplies and related systems. Accordingly, this disclosure includes such methods.

For example, this disclosure includes a method performed by a first device such as a smartphone, a tablet computer, a handheld configurator device, a laptop computer, or a desktop computer. The method includes the first device sending to a server a request (a) to receive files configured for an installation on a second device (e.g., an industrial power supply) and/or on a third device (e.g., an ethernet adapter coupled to the power supply) and (b) to receive instructions for performing the installation of the files on the second device and/or the third device. The first device typically sends the request to the server via the internet. The first device then receives the files and the instructions from the server. The instructions can take the form of a software installation tool and the files can take the form of binary firmware files and/or web server user interface files. The first device executes the instructions, thereby sending the files to the second device and/or the third device as applicable and causes the files to be installed on the second device and/or the third device. For example, the binary firmware files could be installed on the second device and the third device, and the web server user interface files could be installed on the third device.

The above method does not require removal of device housings for firmware installation, nor does the method involve exposing electrical wiring enclosed by the housings. Additionally, there is no need to disconnect any cables from the devices; the existing wiring can be used to facilitate the firmware installation. These methods also do not require the use of custom cables.

Disclosed examples will now be described more fully hereinafter with reference to the accompanying Drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

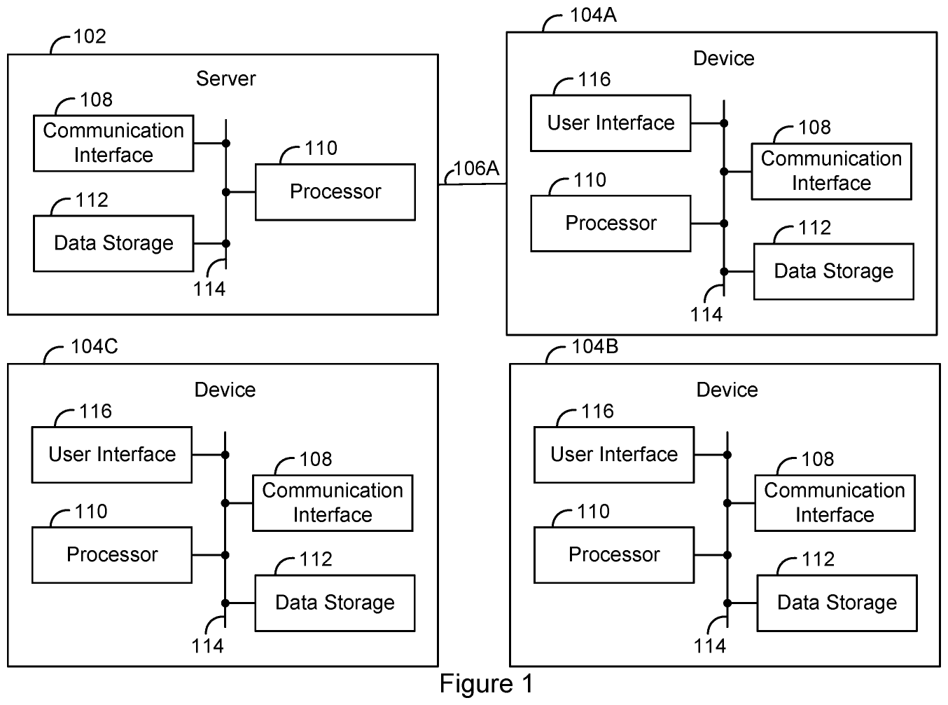

FIG. 1 is a block diagram of a server 102, a device 104A, a device 104B, and a device 104C with which aspects of the present disclosure can be implemented.

The server 102 is configured for performing a variety of functions, such as those described in this disclosure (including the accompanying drawings). For example, the server 102 is configured for communicating with the device 104 via a communication network 106A (e.g., the internet).

The server 102 may take a variety of forms and may include various components, including for example, a communication interface 108, a processor 110, and a data storage 112, all of which may be communicatively linked to each other via a system bus, network, or other connection mechanism 114.

The communication interface 108 may take a variety of forms and is configured to allow the server 102 to communicate with one or more devices according to any number of protocols. For instance, the communication interface 108 is configured to allow the server 102 to communicate with the device 104A via the communication network 106A. In one example, the communication interface 108 may take the form of a wired interface, such as an Ethernet interface. As another example, the communication interface 108 may take the form of a wireless interface, such as a cellular or Wi-Fi interface.

The processor 110 may include a general purpose processor (e.g., a microprocessor) and/or a special purpose processor (e.g., a digital signal processors (DSP)).

The data storage 112 may include one or more volatile, non-volatile, removable, and/or non-removable storage components, such as magnetic, optical, or flash storage, and may be integrated in whole or in part with the processor 110. Further, the data storage 112 may take the form of a non-transitory computer-readable storage medium, having stored thereon program instructions (e.g., compiled or non-compiled program logic and/or machine code) that, when executed by the processor 110, cause the server 102 to perform one or more functions, such as those described in this disclosure.

Likewise, the device 104A, the device 104B, and the device 104C are configured for performing a variety of functions such as those described in this disclosure. The device 104A, the device 104B, and the device 104C may take a variety of forms. The device 104A, the device 104B, and the device 104C may each include various components, including for example, a user interface 116, the communication interface 108, the processor 110, and the data storage 112, all of which may be communicatively linked with each other via a system bus, network, or other connection mechanism 114.

The user interface 116 is configured for facilitating interaction between the device 104 and a user of the device 104, such as by receiving input from the user and providing output to the user. Thus, the user interface 116 may include input components such as a keyboard or a push button. In addition, the user interface 116 may include output components such as a display screen, a sound speaker, or other audio output mechanism.

The data storage 112 may include one or more volatile, non-volatile, removable, and/or non-removable storage components, and may be integrated in whole or in part with the processor 110. Further, the data storage 112 may take the form of a non-transitory computer-readable storage medium, having stored thereon program instructions that, when executed by the processor 110, cause the devices 104 to perform one or more functions, such as those described in this disclosure.

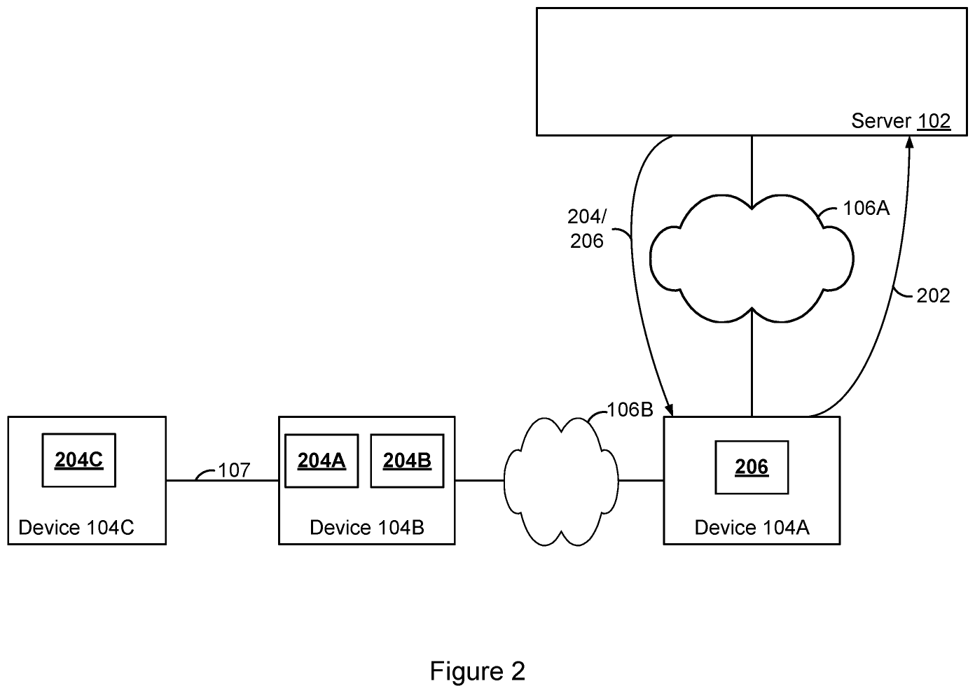

FIG. 2 is a schematic diagram of operations of the server 102, the device 104A, the device 104B, and the device 104C. In some examples, the device 104A is a smartphone, a tablet computer, a handheld device configurator, a laptop computer, or a desktop computer. The device 104B can take the form of an ethernet adapter configured to provide network connectivity for the device 104C via a serial connection 107 and a communication network 106B, which could be a point to point connection, a local area network, or an operation technology that includes one or more switches or routers present at a manufacturing plant. As such, the device 104 is also in communication with the device 104B via the communication network 106B. The device 104C can take the form of an industrial power supply or a UPS system. An application running on the device 104A can facilitate examination of the firmware and user interface presently installed on the device 104B and the device 104C and determine whether they are out of date and ready for replacement by newer revisions available on server 102.

The server 102 receives, from the device 104A via the communication network 106A, a request 202 to receive files 204 configured for an installation on the device 104B and/or on the device 104C and to receive instructions 206 for performing the installation of the files 204 on the device 104B and/or the device 104C.

In some examples, the request 202 includes a user credential (e.g., licensing information, a username, and/or a password). Thus, the server 102 authenticates the user credential and responsively sends the files 204 and the instructions 206 in response to authenticating the user credential.

In various examples, the files 204 include webserver user interface files 204A that, when executed by the device 104B, cause the device 104B to provide a graphical user interface (GUI) that can be accessed on another device via a network connection. That is, a remote device can be used to monitor and/or control the device 104B and/or the device 104C remotely using a GUI that is implemented by the device 104B but displayed on the remote device (e.g., the device 104A).

The files 204 can also include (e.g., encrypted) binary firmware files for installation on the device 104B and/or the device 104C. For example, the binary firmware files 204B are configured for installation on the device 104B and the binary firmware files 204C are configured for installation on the device 104C.

After receiving the request 202, the server 102 sends the files 204 and the instructions 206 to the device 104A via the communication network 106A. In some examples, the server 102 sends a file transfer protocol (FTP) link to the device 104A in response to receiving the request 202 and, receives, from the device 104A, an additional request to receive the files 204 and the instructions 206 via the FTP link. In this context, the server 102 sends the files 204 and the instructions 206 to the device 104A via the FTP link.

The following describes operations from the perspective of the device 104A. The device 104A sends, to the server 102 via the communication network 106A, the request 202 to receive the files 204 and the instructions 206. In some examples, the request 202 includes a user credential and/or licensing details.

In some examples, subsequent to sending the request 202, the device 104A receives a file transfer protocol (FTP) link from the server 102 in response to sending the request 202. As such, the device 104A can send an additional request to receive the files 204 and the instructions 206 via the FTP link. In this context, the device 104A receives the files 204 and the instructions 206 via the FTP link.

Next, the device 104A receives the files 204 and the instructions 206 from the server 102 via the communication network 106A. Subsequently, the device 104A executes the instructions 206, thereby sending the webserver user interface files 204A and the binary firmware files 204B to the device 104B and the binary firmware files 204C to the device 104C (e.g., via the device 104B) thereby causing the binary firmware files 204C to be installed on the device 104C and the webserver user interface files 204A and the binary firmware files 204B to be installed on the device 104B.

The following describes operations from the perspective of the device 104B. The device 104B receives the webserver user interface files 204A, the binary firmware files 204B, and/or the binary firmware files 204C from the device 104A via the communication network 106B while the device 104B is in communication with the device 104C via the serial connection 107. In some examples, the communication between the device 104B and the device 104A is performed via a Transmission Control Protocol/Internet Protocol or a User Datagram Protocol. In examples where the device 104B receives the binary firmware files 204C, the device 104B sends the binary firmware files 204C to the device 104C via the serial connection for installation. Once the files have been received, the device 104B discontinues the communication between the device 104B and the device 104C and thereafter performs an installation of the webserver user interface files 204A and the binary firmware files 204B on the device 104B. The device 104B reboots after the installation and before reestablishing the communication with the device 104C. To discontinue the communication between the device 104B and the device 104C, the device 104B can disable the serial connection 107. Likewise, to reestablish the communication with the device 104C, the device 104B can enable the serial connection 107.

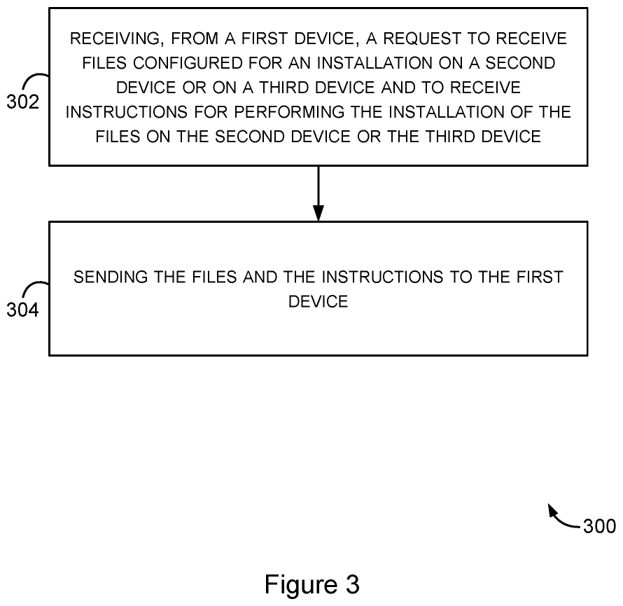

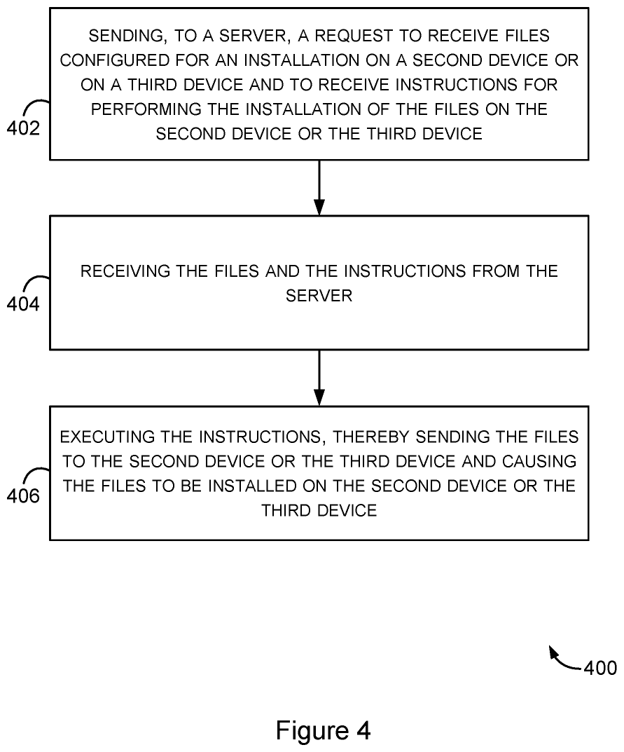

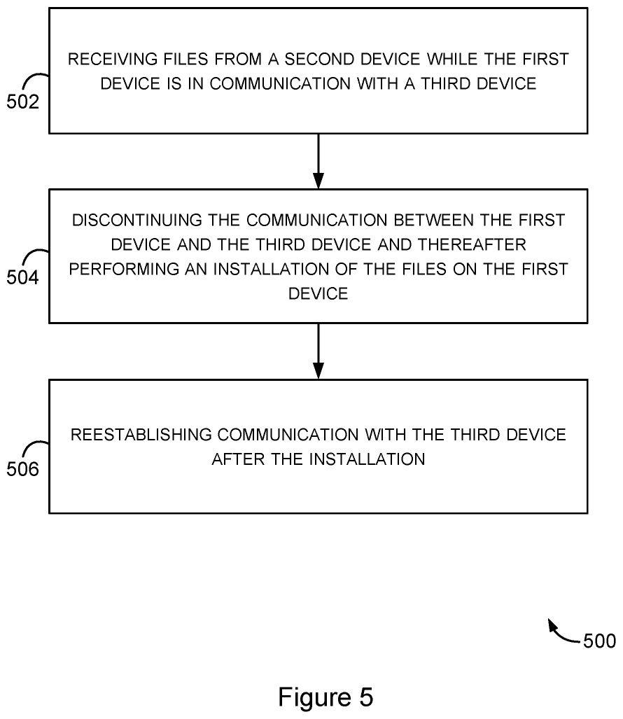

FIG. 3, FIG. 4, and FIG. 5 are block diagrams of a method 300, a method 400, and a method 500, which in some examples are performed by the server 102, the device 104A, or the device 104B. As shown in FIG. 3, FIG. 4, and FIG. 5, the method 300, the method 400, and the method 500 include one or more operations, functions, or actions as illustrated by blocks 302, 304, 402, 404, 406, 502, 504, and 506. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes the server 102 receiving, from the device 104A, the request 202 to receive the files 204 configured for the installation on the device 104B or on the device 104C and to receive the instructions 206 for performing the installation of the files 204 on the device 104B or the device 104C. Functionality related to block 302 is described with reference to FIG. 1 and FIG. 2 above.

At block 304, the method 300 includes the server 102 sending the files 204 and the instructions 206 to the device 104A. Functionality related to block 304 is described with reference to FIG. 1 and FIG. 2 above.

At block 402, the method 400 includes the device 104A sending, to the server 102, the request 202 to receive the files 204 configured for the installation on the device 104B or on the device 104C and to receive the instructions 206 for performing the installation of the files 204 on the device 104B or the device 104C. Functionality related to block 402 is described with reference to FIG. 1 and FIG. 2 above.

At block 404, the method 400 includes the device 104A receiving the files 204 and the instructions 206 from the server 102. Functionality related to block 404 is described with reference to FIG. 1 and FIG. 2 above.

At block 406, the method 400 includes executing the instructions 206, thereby sending the files 204 to the device 104B or the device 104C and causing the files 204 to be installed on the device 104B or the device 104C. Functionality related to block 406 is described with reference to FIG. 1 and FIG. 2 above.

At block 502, the method 500 includes the device 104B receiving the files 204 from the device 104A while the device 104B is in communication with the device 104C. Functionality related to block 502 is described with reference to FIG. 1 and FIG. 2 above.

At block 504, the method 500 includes the device 104B discontinuing the communication between the device 104B and the device 104C and thereafter performing the installation of the webserver user interface files 204A and the binary firmware files 204B on the device 104B. Functionality related to block 504 is described with reference to FIG. 1 and FIG. 2 above.

At block 506, the method 500 includes the device 104B reestablishing communication with the device 104C after the installation. Functionality related to block 506 is described with reference to FIG. 1 and FIG. 2 above.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

1-30. (canceled)

31. A method performed by a first device, the method comprising:
receiving files from a second device while the first device is in communication with a third device;
discontinuing the communication between the first device and the third device and thereafter performing an installation of the files on the first device; and
reestablishing communication with the third device after the installation.

32. The method of claim 31, wherein receiving the files comprises receiving the files via a Transmission Control Protocol/Internet Protocol or a User Datagram Protocol.

33. The method of claim 31, wherein the communication between the first device and the third device is performed via a serial connection between the first device and the third device.

34. The method of claim 31, further comprising rebooting the first device after the installation and before reestablishing the communication.

35. The method of claim 31, wherein the second device comprises a smartphone, a tablet computer, a laptop computer, or a desktop computer.

36. The method of claim 31, wherein the first device comprises an ethernet adapter configured to provide network connectivity for the third device.

37. The method of claim 31, wherein the third device comprises a power supply.

38. The method of claim 31, wherein the files comprise webserver user interface files that, when executed by the first device, cause the first device to provide a graphical user interface that can be accessed on another device via a network connection.

39. The method of claim 38, wherein the graphical user interface is configured for use in monitoring and controlling the third device.

40. The method of claim 31, wherein the files comprise binary firmware files.

41. The method of claim 40, wherein the files are encrypted.

42. A first device comprising:
one or more processors; and
a computer readable medium storing instructions that, when executed by the one or more processors, cause the first device to perform functions comprising:
receiving files from a second device while the first device is in communication with a third device;
discontinuing the communication between the first device and the third device and thereafter performing an installation of the files on the first device; and
reestablishing communication with the third device after the installation.

43. A non-transitory computer readable medium storing instructions that, when executed by one or more processors of a first device, cause the first device to perform functions comprising:
receiving files from a second device while the first device is in communication with a third device;
discontinuing the communication between the first device and the third device and thereafter performing an installation of the files on the first device; and
reestablishing communication with the third device after the installation.

44. The first device of claim 42, wherein receiving the files comprises receiving the files via a Transmission Control Protocol/Internet Protocol or a User Datagram Protocol.

45. The first device of claim 42, wherein the communication between the first device and the third device is performed via a serial connection between the first device and the third device.

46. The first device of claim 42, further comprising rebooting the first device after the installation and before reestablishing the communication.

47. The first device of claim 42, wherein the second device comprises a smartphone, a tablet computer, a laptop computer, or a desktop computer.

48. The first device of claim 42, wherein the first device comprises an ethernet adapter configured to provide network connectivity for the third device.

49. The first device of claim 42, wherein the third device comprises a power supply.

50. The first device of claim 42, wherein the files comprise webserver user interface files that, when executed by the first device, cause the first device to provide a graphical user interface that can be accessed on another device via a network connection.
